(19) United States
(12) Patent Application Publication
(10) Pub. No.: US 2024/0093552 A1
(43) Pub. Date: Mar. 21, 2024

(54) ROLLER SHADE SYSTEM

(71) Applicant: Fernando Newcomb, Hong Kong (HK)

(72) Inventor: Fernando Newcomb, Hong Kong (HK)

(21) Appl. No.: 18/368,053

(22) Filed: Sep. 14, 2023

Related U.S. Application Data
(60) Provisional application No. 63/375,696, filed on Sep. 15, 2022.

(51) Int. Cl. E06B 9/44; E06B 9/78

(52) U.S. Cl. CPC E06B 9/44; E06B 9/78; E06B 2009/785

(57) ABSTRACT

A roller shade system, a roller shade system for all types of glass or transparent windows, a roller shade system for bi-fold doors, a roller shade system for sliding doors, a roller shade system for rolls, a roller shade system for backdrops, process, and method of use are presented. The roller shade system comprises a roller tube, a fabric operably connected to the roller tube. The roller shade system further comprises a clutch connected to the roller tube and a bead chain or cord connected to the clutch for rotating the clutch, and thus the roller tube. The bead chain or cord includes a plurality of raindrop shaped actuators or teardrop shaped balls. The actuators are configured to rotate the clutch bi-directionaly. This arrangement facilitates the user in instantaneously recognizing or identifying which end of the cord needs to be pulled for moving the fabric upward and/or downward.

### CROSS-REFERENCE TO RELATED APPLICATIONS

The present application claims priority to the U.S. Provisional Patent Application No. 63/375,696 which was filed on Sep. 15, 2022, which is hereby incorporated by reference herein in its entirety, including any figures, tables, or drawings.

### FIELD OF THE DISCLOSURE

This disclosure relates to a roller shade system, a roller shade system for all types of glass or transparent windows, a roller shade system for bi-fold doors, a roller shade system for sliding doors, a roller shade system for rolls, a roller shade system for backdrops, process, and method of use. More specifically, and without limitation, the present disclosure relates to a roller shade system for raising and/or lowering a screen for blocking transmission of light and/or ultraviolet light and/or providing a backdrop.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. Fernando Newcomb. All rights reserved.

### BACKGROUND OF THE DISCLOSURE

Roller shades are well known in the art. Furthermore, roller blinds or shades are one of the most practical and low maintenance windows covering options on the market today. A roller blind is generally made up of a single piece of fabric that comes wrapped around a casing. This type of window treatment fits into your pre-existing window frame, either inside or outside. It is operated by pulling a cord attached by sidechaining.

Window blinds or roller blinds provide us with more control over the amount of light entering the room because it can cover the entire window or just part of the window according to the needs. For example, the slats on some window blinds are fitted so tightly together that they do not allow any light in at all. This could be ideal for a room where you have a home theater or in your bedroom where you don't want any light to wake you up in the morning.

The advantages of blinds also include delivering a heightened level of privacy that can't be achieved with many other window covering options. Because blinds can be completely closed, they can make it more difficult for burglars to peek through windows. Further, one of the best things about window blinds is that they are typically very easy to maintain. In fact, many blinds simply require a quick wipe with a damp cloth from time to time to remove the dust.

Unfortunately, from the design of the cords including the little balls used for operating the roller blinds up and down, a user can't immediately tell which way is up or down. Thus, the user needs to follow the trial-and-error method by pulling cords from both the ends to identify which way is up and which way is down, thereby causing inconvenience to the user in operating the roller blind.

Thus, there exists a need in the art to provide a roller shade system that overcomes the above-mentioned problems by providing efficient and improved roller blinds design and mechanism that help the user to immediately identify which way is up and which way is down.

The disclosure herein provides these advantages and others as will become clear from the specification and claims provided.

### SUMMARY OF THE DISCLOSURE

A roller shade system, a roller shade system for all types of glass or transparent windows, a roller shade system for bi-fold doors, a roller shade system for sliding doors, a roller shade system for rolls, a roller shade system for backdrops, process, and method of use are presented.

More specifically, and without limitation, the present disclosure relates to a roller shade system, a roller shade system for all types of glass or transparent windows, a roller shade system for bi-fold doors, a roller shade system for sliding doors, a roller shade system for rolls, a roller shade system for backdrops, process, and method of use are presented. The roller shade system comprises a roller tube, a fabric operably connected to the roller tube. The roller shade system further comprises a clutch connected to the roller tube and a bead chain or cord connected to the clutch for rotating the clutch, and thus the roller tube. The bead chain or cord includes a plurality of raindrop shaped actuators or teardrop shaped balls. The actuators are configured to rotate the clutch bi-directionaly. This arrangement facilitates the user in instantaneously recognizing or identifying which end of the cord needs to be pulled for moving the fabric upward and/or downward.

Thus, it is a primary object of the disclosure to provide a roller shade system, a roller shade system for all types of glass or transparent windows, a roller shade system for bi-fold doors, a roller shade system for sliding doors, a roller shade system for rolls, a roller shade system for backdrops, process, and method of use that improves upon the state of the art.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that provides a user a mechanism for immediately identifying which way to pull the cord in order to move the shade up and/or down.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that provides a user a mechanism for instantly identifying which way to pull the cord in order to move the shade up and/or down.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that opens and closes.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that provides a fabric and/or associated material option variation depending on the needs of a user.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that easily allows a user to move the shade up and/or down.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that provides a unique clutch system for rotation.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that provides an improved grip style over the present state of the art of sphere shaped beads or actuators.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that utilizes a tear-shaped actuator.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that efficiently rotates a roller shade.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that provides a fabric system attached to a roller shade.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that provides a unique clutch system connected to the roller tube and a bead chain or cord which includes a raindrop shaped bead and/or raindrop shaped actuator.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that includes a plurality of raindrop shaped actuators which have a clear indication of a beveled and/or narrowed end opposite a smooth and/or semi-spherical end.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that includes a clutch system with apertures configured to accommodate the tear drop shaped actuators with accurate, close and tight tolerances for smooth operation.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that effectively rotate the clutch with ease by utilizing the uniquely shaped apertures, providing increase force and efficiency over the state of the art.

Another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that enable a user to nearly instantly identify which direction a user should pull the cord and/or upon which cord a user should pull in order to move the roller shade in a desired direction; whether the direction be an upward movement, a downward movement, horizontal movement, angular movement, a combination thereof, or the like.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that is easy to use.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that is safe to use.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that is accurate.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that works with various digital platforms.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that provides a user interface; that can also be controlled by voice commands.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that is quick and efficient.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that is easy to program to a predetermined set of rules.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that is robust.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that saves time for a user.

Yet another object of the disclosure is to provide a roller shade system, a roller shade system for all types of glass or transparent windows, a roller shade system for bi-fold doors, a roller shade system for sliding doors, a roller shade system for rolls, a roller shade system for backdrops, process, and method of use that saves energy.

Another object of the disclosure is to provide a roller shade system, a roller shade system for all types of glass or transparent windows, a roller shade system for bi-f old doors, a roller shade system for sliding doors, a roller shade system for rolls, a roller shade system for backdrops, process, and method of use that are high quality.

These and other objects, features, or advantages of the present disclosure will become apparent from the specification and claims.

### BRIEF DESCRIPTION OF THE DRAWINGS

The drawings accompanying and forming part of this specification are included to depict certain aspects of the disclosure.

FIG. 1 illustrates a perspective view of a raindrop shape or teardrop shape hollow ball, in accordance with some embodiments of the present disclosure.

FIG. 2 illustrates a front view of a raindrop shape or teardrop shape hollow ball, in accordance with some embodiments of the present disclosure.

FIG. 3 illustrates a front view of a raindrop shape or teardrop shape hollow ball, in accordance with some embodiments of the present disclosure.

FIG. 4 illustrates a top view of a raindrop shape or teardrop shape hollow ball, in accordance with some embodiments of the present disclosure.

FIG. 5 illustrates a bottom view of a raindrop shape or teardrop shape hollow ball, in accordance with some embodiments of the present disclosure.

FIG. 6 illustrates an arrangement of a roller shade system, in accordance with some embodiments of the present disclosure.

FIG. 7 illustrates a front view of a clutch of roller shade system, in accordance with some embodiments of the present disclosure.

FIG. 8 illustrates a side view and a perspective view of a clutch of roller shade system, in accordance with some embodiments of the present disclosure.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In one embodiment of the present disclosure, as shown in one example, a roller shade system is disclosed. The roller shade system comprises a roller tube, a fabric attached to the roller tube for winding about and unwinding from the roller tube. The roller shade system further comprises a clutch connected to the roller tube and a bead chain or cord connected to the clutch for rotating the roller tube along with a clutch. The bead chain or cord includes a plurality raindrop shape balls or teardrop shape balls. Each raindrop shape ball or teardrop shape ball comprises a pointed end and a round end. The clutch comprises a plurality of negative spaces for accommodating the one or more raindrop shape or teardrop shape balls.

The one or more raindrop shaped actuators and/or teardrop shaped balls are placed into the negative spaces of the clutch such that the beveled side and/or beveled end opposite the semi-spherical end of the balls facing down on one end of the cord and beveled side of the balls facing up on another end of the cord. The end of the cord having the beveled side of the balls facing down is used to pull the roller fabric downward and the other end of the cord having the beveled side of the balls facing up is used to pull the fabric upward. This arrangement facilitates the user to instantaneously recognize or identify which end of the cord needs to be pulled for moving the fabric upward and downward.

System:

With reference to the figures, a roller shade system, a roller shade system for all types of glass or transparent windows, a roller shade system for bi-fold doors, a roller shade system for sliding doors, a roller shade system for rolls, a roller shade system for backdrops, process, and method of use are presented. A roller shade system, a roller shade system for all types of glass or transparent windows, a roller shade system for bi-fold doors, a roller shade system for sliding doors, a roller shade system for rolls, a roller shade system for backdrops, process, and method of use is formed of any suitable size, shape and design.

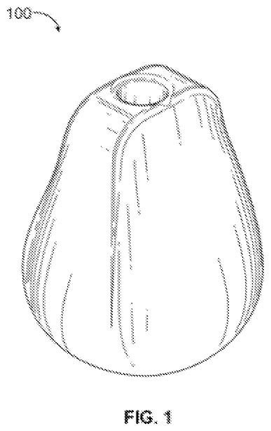

FIG. 1 illustrates a perspective view of a raindrop shape or teardrop shape hollow ball 100, and/or actuator 100 in accordance with some embodiments of the present disclosure.

In the arrangement shown, as one example, the raindrop shape or teardrop shape hollow ball 100 may comprise a tapered or narrow end or beveled end and a round end or spherical end or semi-spherical end. The hollow ball 100 may have a diameter that may allow a thread or a cord to pass through the hollow region of the ball. The hollow region diameter may be selected such that hollow ball 100 may not freely move on the surface of the thread or the cord.

The hollow ball 100 may be made up of durable, corrosion-resistant, and resilient materials such as high-density polyethylene, polypropylene, Teflon® (PTFE) or heat-resistant polyvinylidene fluoride (PVDF), etc. In the arrangement shown, as one example, the hollow ball 100 may be made up of stainless steel or any alloy. However, the material used in making the hollow ball 100 is not limited to the above example and any other type of material is well within the scope of the present disclosure.

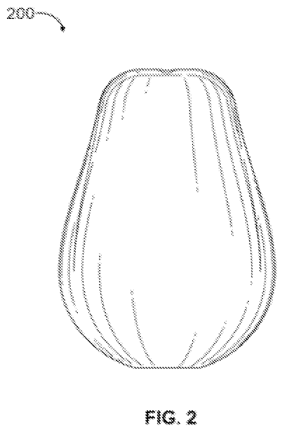

FIG. 2 illustrates a front view of a raindrop shaped or teardrop shaped hollow ball 200, in accordance with some embodiments of the present disclosure. In the arrangement shown, as one example, the hollow ball 200 may have raindrop shaped or teardrop shaped. The hollow ball 200 may comprise a tapered or narrow end and a round end. The hollow ball 200 may be made up of material as discussed in above embodiments.

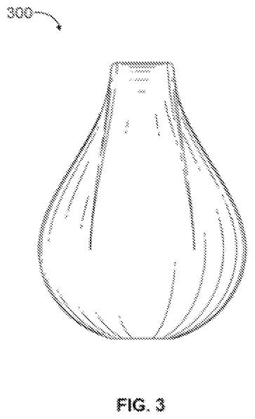

FIG. 3 illustrates a front view of a raindrop shape or teardrop shaped hollow ball, in accordance with some embodiments of the present disclosure.

In an embodiment of the present disclosure, the raindrop shaped or teardrop shaped hollow ball 300 may comprise a pointed end and a round end. The hollow ball 300 may have a diameter that may allow a thread or a cord to pass through the hollow region of the ball. The diameter of the hollow region may be selected such that hollow ball 300 may not freely move on the surface of the thread or the cord. The hollow ball 300 may be made up of material as discussed in above embodiments.

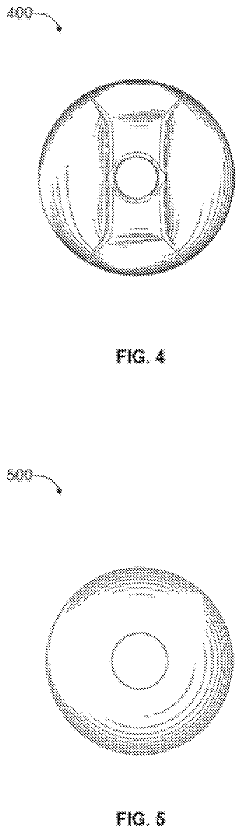

FIG. 4 illustrates a top view of a raindrop shaped or teardrop shaped hollow ball 400, in accordance with some embodiments of the present disclosure. The top end of the hollow ball 400 may be pointed or tapered such that the top end appears different from the bottom end. The hollow ball 400 comprises a hollow channel for inserting a cord or thread. The diameter of the thread and hollow channel is selected such that hollow ball 400 may not freely move on the thread or cord. The hollow ball 400 may be made up of material as discussed in above embodiments.

FIG. 5 illustrates a bottom view of a raindrop shaped or teardrop shaped hollow ball 500, in accordance with some embodiments of the present disclosure. The bottom end of the hollow ball 500 may have a round shaped. The hollow ball 500 may be made up of material as discussed in above embodiments.

In some embodiment of the present disclosure, the raindrop or teardrop shaped of the hollow ball 100, 200, 300, 400, 500 i.e., one end is tapered or pointed and other end is round facilitating the user to instantaneously recognize or identify which end of the cord or thread of the roller shade system to be pulled for moving the fabric upward and downward.

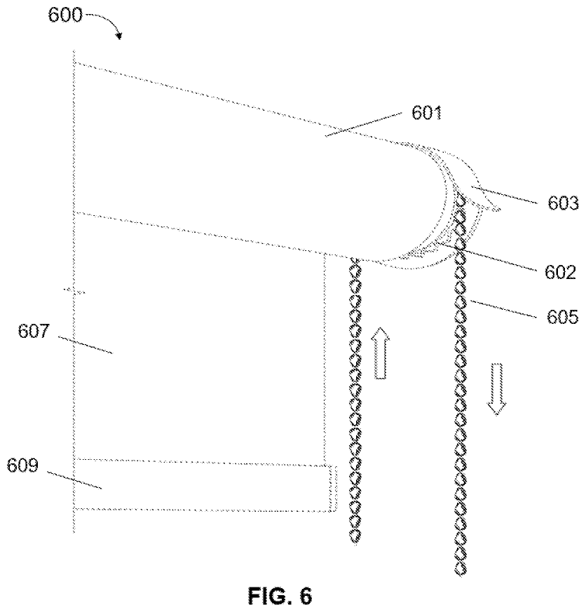

FIG. 6 illustrates an arrangement of a roller shade system 600, in accordance with some embodiments of the present disclosure.

In an embodiment of the present disclosure, a roller shade system 600 may comprise a roller tube 601, a clutch 602 connected one end of the roller tube 601, and an end cap 603 covering or encasing the clutch 602. The end cap 603 may comprise a drive end bracket for supporting wall mounting. The other end of the roller tube 601 may comprise an idle end bracket for attaching the other end of the roller tube 601 to the wall.

In one non-limiting embodiment of the present disclosure, the roller tube 601 and the clutch 602 may be optionally mounted on a stationary shaft connected to the end cap 603, and the roller tube 601 and the clutch 602 may rotate around the stationary shaft. In one non-limiting embodiment, the clutch 602, the roller tube 601, and the end cap 603 may be made up of plastic, steel, alloy or any other material know to a person skilled in the art.

In an embodiment of the present disclosure, the roller tube 601 may comprise an adhesive strip for attaching a fabric 607 to the roller tube 601 for winding about and unwinding from the roller tube 601. The fabric 607 may be made up of opaque or translucent material selected based on a choice of the user and the amount of light user may want to pass through the roller shade system 600.

In an embodiment, the roller shade system 600 may comprise a bead chain or cord 605 connected to the clutch 602 for rotating the roller tube 601 along with clutch 602. The bead chain or cord 605 includes a plurality raindrop shaped balls or teardrop shaped hollow balls 100, 200, 300, 400, 500 having a hollow region for accommodating a thread or a cord. The hollow balls 100, 200, 300, 400, 500 may be made up of material discussed in above embodiments. Also, the thread or cord may be made of appropriate strength to handle the pull force applied by the user.

In an embodiment, the raindrop shaped ball or teardrop shaped ball comprises a pointed or tapered end and a round end. The clutch 602 may comprise a plurality of negative spaces for accommodating the one or more raindrop shaped or teardrop shaped balls inside it. The wall of the clutch 602 and negative spaces allow or guide the balls to fit perfectly. The cord or thread may be inserted in to the plurality of raindrop shaped ball or teardrop shaped balls such that pointed or tapered end are aligned in the same direction.

In an embodiment, the bead chain or cord 605 comprising the raindrop shaped or teardrop shaped balls are placed into the negative spaces of the clutch 602 such that the bead chain or cord 605 hangs on both the ends of the clutch 602. Further, the beveled or tapered side of the balls faces down on one end of the cord and the beveled or tapered side of the balls faces up on another end of the cord, as shown in FIG. 6.

The end of the cord having beveled side of the balls facing down is used to pull the fabric 607 downward and the other end of the cord having beveled side of the balls facing up is used to pull the fabric 607 upward. This arrangement of the pointy side of the balls in the bead chain or cord 605 facilitates the user to instantaneously recognize or identify which end of the cord needs to be pulled for moving the fabric 607 upward and downward.

In an embodiment of the present disclosure, the roller shade system 600 may comprise a bottom rail 609 attached to the other end of the fabric 607 to restrict the lateral movement of the fabric 607 against the wind. It is to be noted the components of the roller shade system 600 discussed in above embodiments are exemplary and the roller shade system 600 may comprise any other necessary components known to a person skilled in the art required for proper function of the roller shade system 600.

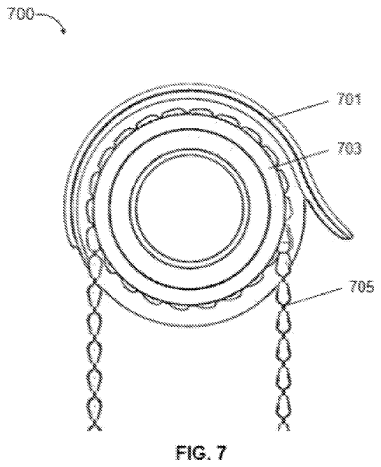

FIG. 7 illustrates a front view 700 of a clutch of roller shade system, in accordance with some embodiments of the present disclosure.

In an embodiment of the present disclosure, the clutch 703 may have negative spaces to accommodate some of the raindrop shaped or teardrop shaped balls of the bead chain or cord 705 and the entire assembly of the clutch 703 is encased within the end cap 701. The bead chain or cord 705 is placed on the negative spaces of the clutch 703 such that equal amount of clutch 703 hangs on both end of the clutch 703.

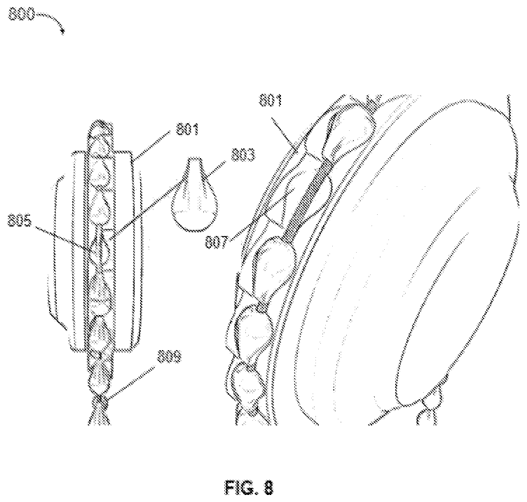

FIG. 8 illustrates a side view and a perspective view 800 of a clutch of roller shade system, in accordance with some embodiments of the present disclosure.

In an embodiment of the present disclosure, the clutch 801 may comprise plurality of negative spaces 805, 807, each negative space 805, 807 may accommodate a raindrop shaped or teardrop shaped ball 803 having one pointed end and a round end. The clutch 801 may be circular in shaped for facilitating rotation motion of the roller tube connected to the clutch 801.

In an embodiment, a bead chain or cord 809 comprising the raindrop shaped or teardrop shaped balls are placed into the negative spaces 805, 807 present in the clutch 801 such that the bead chain or cord 809 hangs on both the ends of the clutch 801. Further, the beveled or tapered side of the balls faces down on one end of the cord and the beveled or tapered side of the balls faces up on another end of the cord.

The end of the cord having a beveled side of the balls facing down is used to pull the fabric connected to the roller tube downward and the other end of the cord having beveled side of the balls facing up is used to pull the fabric connected to the roller tube upward. This arrangement of the beveled side of the balls in the bead chain or cord 809 facilitates the user to instantaneously recognize or identify which end of the cord needs to be pulled for moving the fabric upward and downward.

User (or Plurality Thereof):

In the arrangement shown, as one example, system 10 includes a user. User 11 may be any user interacting with or utilizing the system 10. This may include viewing, controlling, analyzing, manipulating, and/or interacting with system 10. User 11 is not limited to a single user but may be a plurality of users.

Actuator:

In the arrangement shown, as one example, system includes an actuator 100/200/300/400/500 (also referred to as “balls”). The plurality of actuators are formed of any suitable size, shape, and design, and is configured to cause the clutch to rotate when the string and/or cord upon which the plurality of actuators are attached to is pulled and/or forced into movement. Similarly, voice command and the like may be utilized to cause the string and/or chain and/or cord to activate via a motor or the like. The actuators are formed of a generally smooth surface which extends from a semi-spherical end to a beveled end, having an aperture therethrough for a cord and/or chain to pass through and be connected to the actuator.

Graphical User Interface:

In the arrangement shown, as one example, system may include a graphical user interface. Graphical user interface is formed of any suitable size shape and design and is configured to allow a user to view interact with, manipulate, and visually access system data and information, information related thereto, and/or view various data for various environments and/or add information to system and/or environment and/or change the settings of the sensors and/or change the settings of operation.

Computing Platform:
In the arrangement shown, as one example, system includes a computing platform (or “computer”, or “computer platform”). Computing platform is formed of any suitable size, shape, and design and is configured to provide computing support, power, and computing processing for both onboard computing functionality as well as communication for off-board or server computing functionality. In this way, an onboard computing system, among other components and features on top of the platform.

Onboard Computing System:

In one arrangement, as is shown, system 10 includes an onboard computing system (or “onboard computing device”). Onboarding computing system is formed of any suitable size, shape, and design and configured to handle onboard computing operations, as are necessary for the operation of system 10. Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Plurality of Batteries:

In the arrangement shown, as one example, the system may also have a power source. Power source is formed of any suitable size, shape, and design. Power source may be a wall socket, a plurality of batteries, a plurality of rechargeable batteries, a solar power source, or the like, the solar power source may be built into the shade fabric, or the like.

Antenna:

In the arrangement shown, as one example, the system may also include an antenna built into the roller shade system for sending and receiving signals.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A roller shade system, comprising:
a roller;
the roller extending a length from a first end to a second end;
a clutch;
the clutch having a plurality of apertures;
wherein the clutch is operably connected to one of the first end or the second end of the roller; such that when the clutch spins around an axis the roller spins around an axis;
a plurality of actuators;
each of the plurality of apertures extending a length from a first end to a second end;
each of the first ends of the plurality of apertures being beveled in shape;
each of the second ends of the plurality of apertures being semi-spherical in shape;
a cord;
the cord connected to the plurality of actuators;
a shade material.

2. The system of claim 1, further comprising:
the roller having an end cap on the first end.

3. The system of claim 1, further comprising:
the roller having an end cap on the second end.

4. The system of claim 1, further comprising:
the roller having an end cap on the first end;
the roller having an end cap on the second end.

5. The system of claim 1, further comprising:
a second clutch;
the second clutch having a plurality of apertures;
wherein the plurality of apertures are configured in approximately equally spaced distances around the circumference of the second clutch;
wherein the second clutch is operably connected to one of the first end or the second end of the roller; such that when the second clutch spins around an axis the roller spins around an axis.

6. The system of claim 1, further comprising:
wherein the plurality of apertures are configured in approximately equally spaced distances around the circumference of the clutch.

7. The system of claim 1, further comprising:
each of the plurality of apertures being connected to the cord facing in the same direction;
wherein the same direction is the beveled end of a each of the plurality of apertures faces the semi-spherical end of each of the plurality of apertures along the cord;
each of the plurality of apertures having an aperture which the cord passes through;
each of the plurality of actuators connected to the cord at a fixed location along the length of the cord.

8. The system of claim 1, further comprising:
the cord extending a length in a continuous loop.

9. The system of claim 1, further comprising:
the plurality of actuators connected to the cord at equal intervals.

10. The system of claim 1, further comprising:
the cord extending a length in a continuous loop;
the plurality of actuators connected to the cord at equal intervals;
the plurality of actuators connected to the cord for the entire length of the continuous loop of the cord.

11. The system of claim 1, further comprising:
a fabric;
the fabric operably connected to the roller;
the fabric configured to roll around the roller and itself so as to wrap around the roller when deactivating; so as to unwrap around the roller when activating.

12. The system of claim 1, further comprising:
wherein the shade material is a fabric.

13. The system of claim 1, further comprising:
a rail;
the rail connected to the end of the fabric opposite the operable connection to the roller of the fabric.

14. The system of claim 1, further comprising:
a rail;
the rail connected to the end of the fabric opposite the operable connection to the roller of the fabric;
the rail providing a weighted end of the fabric.

15. An actuator, comprising:
a first spherical end;
a second beveled end;
an aperture;
wherein the actuator is configured to have identifying ends such that the actuator can be utilized to move a roller shade bi-directionally.

16. The system of claim 15, further comprising:
a roller;
the roller extending a length from a first end to a second end;
a clutch;
the clutch having a plurality of apertures;
wherein the clutch is operably connected to one of the first end or the second end of the roller; such that when the clutch spins around an axis the roller spins around an axis;
a plurality of actuators;
each of the plurality of apertures extending a length from a first end to a second end;
each of the first ends of the plurality of apertures being beveled in shape;
each of the second ends of the plurality of apertures being semi-spherical in shape;
a cord;
the cord connected to the plurality of actuators;
a fabric;
the fabric operably connected to the roller;
the fabric configured to roll around the roller and itself so as to wrap around the roller when deactivating; so as to unwrap around the roller when activating.

17. The system of claim 15, further comprising:
a roller;
the roller extending a length from a first end to a second end;
a clutch;
the clutch having a plurality of apertures;
wherein the clutch is operably connected to one of the first end or the second end of the roller; such that when the clutch spins around an axis the roller spins around an axis;
a plurality of actuators;
each of the plurality of apertures extending a length from a first end to a second end;
each of the first ends of the plurality of apertures being beveled in shape;
each of the second ends of the plurality of apertures being semi-spherical in shape;
a cord;
the cord connected to the plurality of actuators;
a fabric;
the fabric operably connected to the roller;
the fabric configured to roll around the roller and itself so as to wrap around the roller when deactivating; so as to unwrap around the roller when activating.

18. The system of claim 15, further comprising:
a roller;
the roller extending a length from a first end to a second end;
the roller having an end cap on the first end;
the roller having an end cap on the second end;
a clutch;
the clutch having a plurality of apertures;
wherein the clutch is operably connected to one of the first end or the second end of the roller; such that when the clutch spins around an axis the roller spins around an axis;
a plurality of actuators;
each of the plurality of apertures extending a length from a first end to a second end;
each of the first ends of the plurality of apertures being beveled in shape;
each of the second ends of the plurality of apertures being semi-spherical in shape;
wherein the plurality of apertures are configured in approximately equally spaced distances around the circumference of the clutch;
a cord;
the cord connected to the plurality of actuators;
a fabric;
the fabric operably connected to the roller;
the fabric configured to roll around the roller and itself so as to wrap around the roller when deactivating; so as to unwrap around the roller when activating.

19. A method of operating a roller shade, comparing the steps:
providing a roller shade assembly having a plurality of actuators, the plurality of actuators each shaped having a first smooth semi-spherical end and a second beveled end; the roller shade assembly having a clutch operably connected to a roller;
providing a plurality of actuators connected to a cord at equal intervals;
identifying a direction of the plurality of actuators; wherein the direction is the alignment and direction of which the beveled end of the plurality of actuators are pointing; wherein pointing is the direction the beveled end of the each of the plurality of actuators is directionally facing;
identifying activating or deactivating the roller shade assembly; wherein activating the roller shade assembly is closing the roller shade assembly and deactivating the roller shade assembly is opening the roller shade assembly;
pulling the cord in the direction of activating or the direction of deactivating.

20. The method of claim 19, further comprising:
identifying two cord options hanging from the roller shade assembly; wherein the two cord options form the continuous loop of the cord;
pulling on one of the two cord options;
causing activating or deactivating of the roller shade assembly based on the appearance of one of the two cord options.
